(19) United States
(12) Patent Application Publication
(10) Pub. No.: US 2026/0066993 A1
(43) Pub. Date: Mar. 5, 2026

(54) ACTIVE OPTICAL INTERCONNECT WITH MULTIPLE LIGHT SOURCES AND METHOD OF MODULATION

(71) Applicant: Hyperlume Inc., Ottawa (CA)

(72) Inventors: Hossein Fariborzi, Auburndale, MA (US); Mohsen Asad, Ottawa (CA)

(73) Assignee: Hyperlume Inc., Ottawa (CA)

(21) Appl. No.: 19/066,153

(22) Filed: Feb. 28, 2025

Related U.S. Application Data
(63) Continuation of application No. PCT/CA2024/051134, filed on Aug. 30, 2024.

(51) Int. Cl. H04B 10/524; G02B 6/42; H04B 10/25; H04B 10/40; H04B 10/67; H04B 10/80

(52) U.S. Cl. CPC H04B 10/524; G02B 6/4246; H04B 10/25; H04B 10/40; H04B 10/67; H04B 10/801

(57) ABSTRACT

A parallel interconnect system for transmitting data comprising: a plurality of light sources for emitting light for use as a carrier for the data; a first optical transceiver array having at least one optical transmitter; at least one fiber array configured to transmit light emitted by the at least one optical transmitter; an first optical coupler configured to couple the plurality of light sources to one end of the at least one fiber array; a second optical transceiver array having at least one optical receiver; a second optical coupler configured to receive and direct the transmitted light from another end of at least one fiber array to the second optical transceiver array.

### FIELD

Aspects of the disclosure relate to methods and systems for communication systems.

### BACKGROUND

The demand for advanced computing and networking capabilities is growing, driven by the need for higher speeds and greater density in applications ranging from data center servers and high-performance computing clusters to artificial neural networks and network switches. Historically, the enhancements in integrated circuit (IC) performance and cost efficiency have been fueled by the miniaturization of transistor sizes and the expansion of die sizes, a trend encapsulated by the renowned Moore's Law. This evolution has enabled billions of transistors to be integrated into a single system-on-a-chip (SoC), consolidating functions that used to be spread over multiple ICs.

However, data transmission within and between large IC chips can lead to higher power consumption and increased design complexity, especially in chips that operate at high clock speeds. When IC chips are packaged together within a single unit, the challenge of managing power and complexity in communications between the chips intensifies.

Optical links, in principle, offer a solution for reducing power consumption in chip-to-chip communications. Traditionally, lasers have been employed in long-distance fiber optic communication due to their efficiency. Nonetheless, laser systems, including edge-emitting lasers and vertical cavity surface-emitting lasers (VCSELs), often demand significant drive power, occupy more space, and struggle to perform under the high-temperature conditions typical of intra-chip and inter-chip connections.

MicroLED technology can facilitate optical communication between multiple chips, such as those found in a multi-chip module or a semiconductor package that houses several integrated circuit chips. Optical connections might employ optical coupling mechanisms, including lenses and/or mirrors, for instance.

In various configurations, microLEDs and photodetector arrays are deployed to establish full duplex parallel communication links.

### SUMMARY

In one of its aspects, a communication system comprising:
a plurality of light sources for emitting light;
an optical coupler configured to couple the plurality of light sources to a single fiber;
a modulator for modulating transmission of data using at least one modulation scheme;
a transmitter coupled to the optical coupler for data transmission via the single fiber;
a receiver for receiving the modulated data.

In another of its aspects, a parallel interconnect system for transmitting data comprising:
a plurality of light sources for emitting light for use as a carrier for the data;
a first optical transceiver array having at least one optical transmitter;
at least one fiber array configured to transmit light emitted by the at least one optical transmitter;
an first optical coupler configured to couple the plurality of light sources to one end of the at least one fiber array;
a second optical transceiver array having at least one optical receiver;
a second optical coupler configured to receive and direct the transmitted light from another end of at least one fiber array to the second optical transceiver array.

In another of its aspects, an optical interconnect system for transmitting data comprising:
a plurality of light sources for emitting light for use as a carrier for the data;
a first optical transceiver array having at least one optical transmitter;
at least one fiber array configured to transmit light emitted by the at least one optical transmitter, wherein the first optical transceiver array is butt-coupled to the first end of the at least one fiber array;
a second optical transceiver array having at least one optical receiver, wherein the second optical transceiver array is butt-coupled to a second end of the at least one fiber array to receive and direct the transmitted light.

The implementation leverages advancements in the optical device technologies initially developed for display purposes to overcome challenges in short-distance data communication. These innovations enable the creation of devices capable of establishing fast, energy-efficient, compact, and cost-effective short-distance data links. Such technologies facilitate data exchange both within a single module, containing multiple integrated circuits (ICs), and between separate modules over distances of up to several meters.

In particular, these examples utilize optical interconnects, which may involve one or more microLEDs to emit light for data transmission from one part to another within the same component, or between different components. This approach includes transferring data across chips within a multi-chip module, from one section of a chip to another within the same chip, or across a substrate like an interposer that serves either to facilitate intra-chip communication or connect multiple chips within a module.

Optical communication between semiconductor chips may be executed via a parallel microLED interconnect (PMI), comprising arrays of transmitters and receivers linked by a medium through which the signal propagates. A transmitter in this setup includes the necessary circuitry, a microLED, and optics for light collection. Conversely, a receiver encompasses optics for collecting light, a photodetector, and the corresponding receiver circuitry. These components can be packaged together within the same unit or attached to the same substrate. The configurations may vary, including chips within the same or different modules, and modules located on the same or different shelves or racks.

The propagation medium for these optical signals might consist of planar waveguides on a substrate, multicore fibers, or coherent fiber bundles, facilitating efficient data transfer. The design also contemplates free-space regions incorporating lenses, mirrors, and other optical elements for light manipulation.

MicroLEDs can be directly attached to a microfiber's end or connected through light collection optics, including lenses or mirrors. These setups might involve turning mirrors or grating couplers to direct light into waveguides, enhancing the efficiency of the optical link.

Furthermore, the end of a waveguide can be directly attached to a photodetector or connected through receiver optics, facilitating the precise capture of transmitted light. Optical buses within this system may feature tapped bus links with master and slave nodes for distributing signals.

In some examples, multiple microLEDs can be connected to a single fiber, improving the overall bandwidth by increasing the effective number of bits being transmitted at a given time period.

The described examples provide systems for optical communication both within a single chip and between multiple chips, incorporating waveguides, microLEDs, and photodetectors to facilitate efficient data transmission. These systems represent significant advancements in inter-and intra-chip communication, promising enhanced performance for integrated circuits.

### BRIEF DESCRIPTION OF THE DRAWINGS

Several exemplary embodiments of the present disclosure will now be described, by way of example only, with reference to the appended drawings in which:

FIG. 1 shows a block diagram of a parallel microLED interconnect system;

FIG. 2a shows a cross section of a microfiber with two microLEDs;

FIG. 2b shows a cross section of a microfiber with three microLEDs;

FIG. 2c shows a truth table corresponding to FIG. 2b;

FIG. 3 shows a depicts one example of the system for realizing multi-bit transmission with single microfiber;

FIG. 4a shows depicts one example of the system for realizing multi-bit transmission with single microfiber;

FIG. 4b shows the 4 bit output corresponding to the input combination;

FIG. 5a depicts one example of the system for realizing 4-bit transmission with a single microfiber with PAM4 modulation;

FIG. 5b shows the 4 bit output corresponding to the input combination;

FIG. 6a shows a PAM 16 implementation with 6 identical microLEDs;

FIG. 6b shows a truth table corresponding to FIG. 6a;

FIG. 7a depicts a PAM16 implementation with two sets of different sized LEDs; and

FIG. 7b shows a truth table corresponding to FIG. 7a.

### DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Looking at FIG. 1, there is shown a block diagram of a parallel microLED interconnect system 10, in one example. The parallel microLED interconnect system 10 comprises first optical coupling module 12 which couples light between first optical transceiver array 14 and as a transmission medium 16, such as a microfiber array, and second optical coupling module 18 which couples light between the microfiber array 16 and second optical transceiver array 20. The first optical transceiver array 14 may include an optical transmitter with at least one microLED as a light source, and the second optical transceiver array 20 may include an optical receiver with least one photodetector.

In another example, the parallel microLED interconnect 10 comprises two or more first optical transceiver arrays 14, two or more first optical coupling modules 12, microfiber array 16, and two or more second optical transceiver arrays 20, two or more second optical coupling modules 18.

In another example, the first optical transceiver array 14 is electrically coupled to a first integrated circuit chip or a first area of an integrated circuit chip. In another example, the second optical transceiver array 20 is electrically coupled to a second integrated circuit chip or a second area of the integrated circuit chip.

In another example, the first integrated circuit chip and drivers for microLEDs of the first optical transceiver array 14 are mounted to a common substrate. In another example, the second integrated circuit chip and drivers for the microLEDs of the second optical transceiver array 20 are mounted to a common substrate.

In another example, the first optical transceiver array 14 comprises only optical transmitters and the second transceiver array 20 comprises only optical receivers. In another example, each transceiver array 14, 20 comprises both optical transmitters and receivers, in many such examples equal numbers of optical transmitters and receivers. In some examples, one or both optical coupling assemblies 12, 18 are omitted so that one or both transceiver arrays are butt-coupled to the optical propagation medium 16.

In another example, an inter-or intra-chip optical communication system, comprising a multicore microfiber; a first photodetector electrically coupled to a first integrated circuit chip and optically coupled to the microfiber; and two microLEDs electrically coupled to the first integrated circuit chip and optically coupled to a single microfiber.

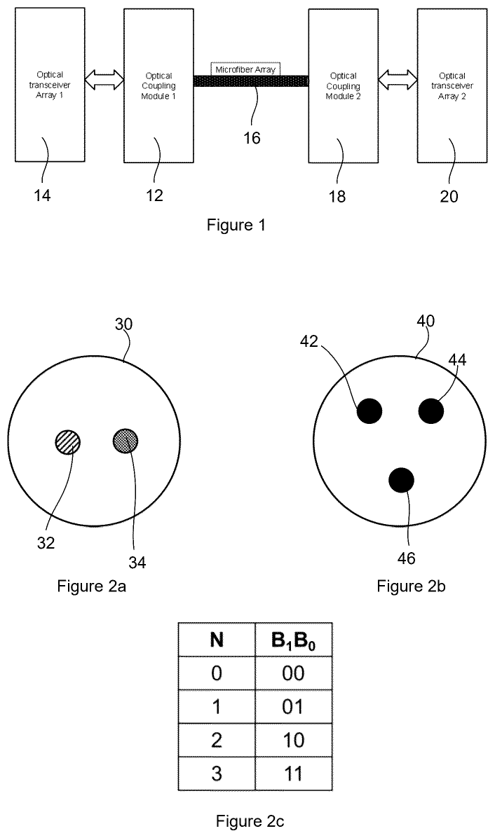

FIG. 2a depicts the cross section of a microfiber 40 with two microLEDs 32, 34, optically coupled thereto. In this example, the two microLEDs 32, 34 have different structures and show significant difference in wavelength, which allows for orthogonality.

FIG. 2b depicts the cross section of a microfiber 40 with three microLEDs 42, 44 ,46 optically coupled thereto. In this example, the three microLEDs 42, 44 ,46 have the same structure. The number of microLEDs 42, 44 ,46 in the on-state (N) represents the transmitted bits, as shown in FIG. 2c.

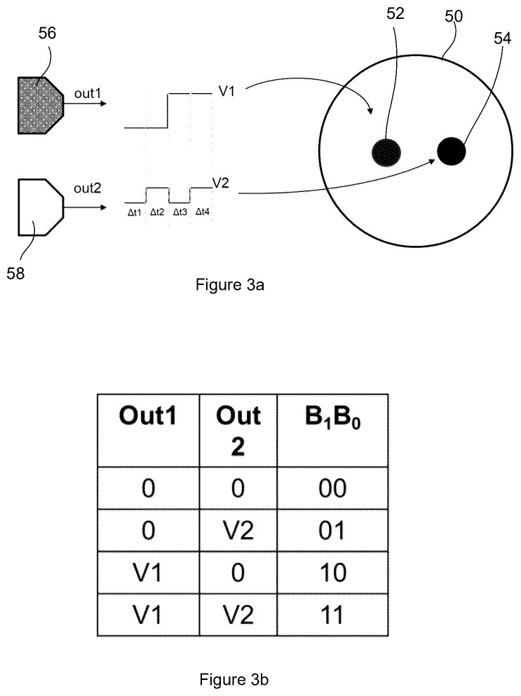

FIG. 3a depicts one example of the system 10 for realizing multi-bit transmission with a single microfiber 50 using microLEDS 52, 54 driven by drivers 56, 58, respectively. In this example, the microLEDs 52, 54 are the same, however the drivers 56, 58 are different, and provide different driving strength and illumination for the microLEDs 52, 54. The microLEDs provide 4 different illumination levels, which will translate to two distinct bits in the second optical transmitter array 20, as shown in FIG. 3b. The strong driver 56 drives microLED 52 with Voltage V1, providing the most valuable bit (MSB) and the weak driver 58 drives microLED 54 with voltage V2, where V2<V1 providing the least valuable bit (LSB).

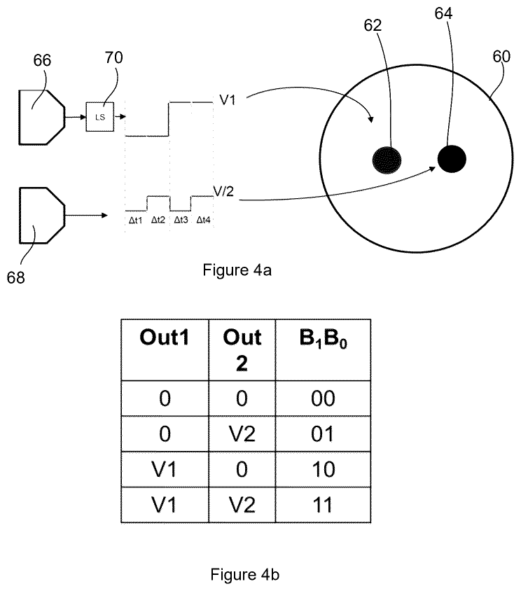

FIG. 4a depicts one example of the system 10 for realizing multi-bit transmission with single microfiber 60 using microLEDS 62, 64 driven by drivers 66, 68, respectively. In this example, the microLEDs 52, 54 are the same, and the drivers 66, 68 are also the same, and providing identical driving strength for the microLEDs 62, 64. Driver 68 (weak driver) drives microLED 64 with voltage V2, where V2<V1 providing the least valuable bit (LSB). A level shifter 70 is coupled to an output of driver 66 and provides the required higher driving voltage V1 to enable the microLEDs 62, 64 to provide 4 different illumination levels, which will translate to two distinct bits of data in the second optical transmitter array 20, as shown in FIG. 4b.

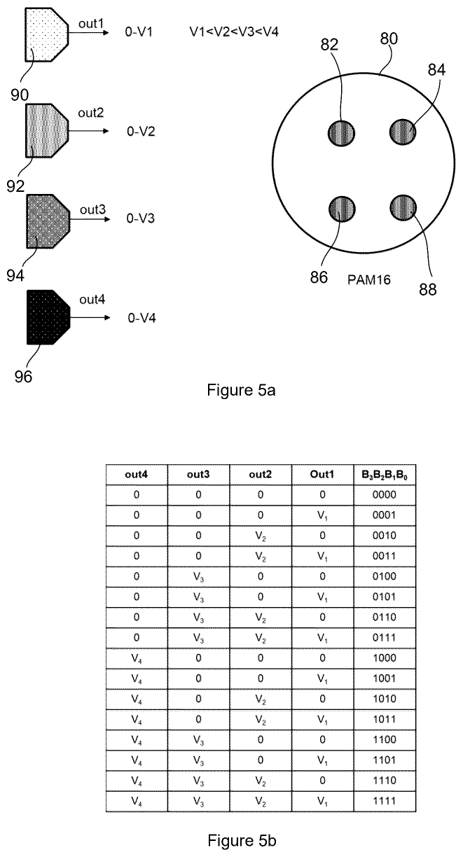

FIG. 5 depicts one example of the system 10 for realizing 4-bit transmission with a single microfiber 80 with PAM4 modulation, using four microLEDS 82, 84, 86, 88, driven by four different drivers 90, 82, 94, 96, respectively. In one example, drivers 90, 82, 94, 96 provide driving voltages V1, V2, V3, V4, each with different magnitudes, e.g. V1<V2<V3<V4. FIG. 5b shows the 4 bit output corresponding to the input combination.

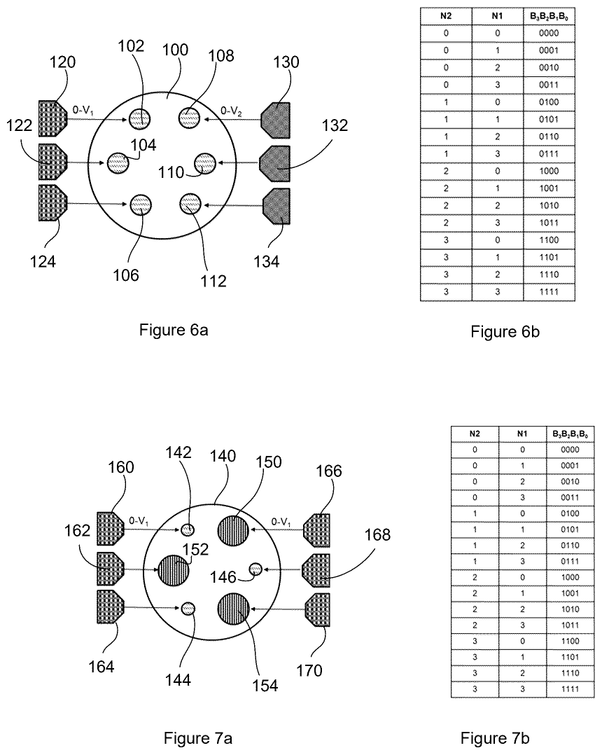

FIG. 6a depicts one example of the system 10 for realizing 4-bit transmission with PAM 16 implementation with a single microfiber 100, using six identical microLEDS 102, 104, 106, 108, 110, 112, driven by two sets of drivers, 122, 124, 130, 132, 134, respectively. In one example, drivers 120, 122, 124 each provide driving voltage V1 to microLEDS 102, 104, 106, while drivers 130, 132, 132 each provide driving voltage V2 to microLEDS 108, 110, 112. The output power of each microLED 108, 110, 112 driven by stronger drivers 130, 132, 134 exceeds that of all 3 microLEDs 102, 104, 106 driven by weaker drivers 120, 122, 124. In the truth table, as shown in FIG. 6b, N2 represents the number of microLEDs 108, 110, 112 that are driven by the strong driver 130, 132, 134, encoding the two MSBs of the transmitted data.

FIG. 7a depicts one example of the system 10 for realizing 4-bit transmission with PAM 16 implementation with a single microfiber 140, using two sets of different sized microLEDS 142, 144, 146 and 150, 152, 154, driven by identical drivers, 160, 162, 164, 66, 168, 170, respectively. In the truth table, as shown in FIG. 7b, N1 represents the number of small LEDs 142, 144, 146 that are turned on, encoding the two LSBs of the transmitted data. Also, in the truth table, N2 represents the number of large LEDs 150, 152, 154 that are turned on, encoding the two MSBs of the transmitted data.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Accordingly, the above description of example implementations does not define or constrain this disclosure. Other changes, substitutions, and alterations are also possible without departing from the spirit and scope of this disclosure.

1. A communication system comprising:
a plurality of light sources for emitting light;
an optical coupler configured to couple the plurality of light sources to a single fiber;
a modulator for modulating transmission of data using at least one modulation scheme;
a transmitter coupled to the optical coupler for data transmission via the single fiber;
a receiver for receiving the modulated data.

2. The communication system of claim 1, wherein the optical coupling mechanism comprises at least one of a lens and a mirror.

3. The communication system of claim 1, wherein the at least one modulation scheme comprises creating a plurality of intensity states associated with a plurality of logic states.

4. The communication system of claim 3, wherein the at least one modulation scheme is pulse amplitude modulation (PAM); and comprises at least one of PAM 4, PAM 8 and PAM 16 modulation schemes.

5. A parallel interconnect system for transmitting data comprising:
a plurality of light sources for emitting light for use as a carrier for the data;
a first optical transceiver array having at least one optical transmitter;
at least one fiber array configured to transmit light emitted by the at least one optical transmitter;
a first optical coupler configured to couple the plurality of light sources to one end of the a t least one fiber array ;
a second optical transceiver array having at least one optical receiver;
a second optical coupler configured to receive and direct the transmitted light from another end of at least one fiber array to the second optical transceiver array.

6. The parallel interconnect system of claim 5, wherein the first optical transceiver array comprises at least one optical transmitter, at least one microLED as the light source, and at least one driver for the at least one microLED.

7. The parallel interconnect system of claim 5, wherein the second optical transceiver array comprise at least one optical receiver and at least one photodetector.

8. The parallel interconnect system of claim 7, wherein the first optical transceiver array is electrically coupled to a first integrated circuit chip or a first area of an integrated circuit chip.

9. The parallel interconnect system of claim 8, wherein the first integrated circuit chip and the at least one driver for the at least one microLED of the first optical transceiver array are mounted on a common substrate.

10. The parallel interconnect system of claim 7, wherein the second optical transceiver array is electrically coupled to a second integrated circuit chip or a second area of an integrated circuit chip.

11. The parallel interconnect system of claim 10, wherein the second integrated circuit chip is mounted to a common substrate.

12. The parallel interconnect system of claim 11, wherein the first optical transceiver array comprises the at least one optical transmitter and the least one optical receiver; and wherein the second optical transceiver array comprises the at least one optical transmitter and the least one optical receiver.

13. An optical interconnect system for transmitting data comprising:
a plurality of light sources for emitting light for use as a carrier for the data;
a first optical transceiver array having at least one optical transmitter;
at least one fiber array configured to transmit light emitted by the at least one optical transmitter, wherein the first optical transceiver array is butt-coupled to the first end of the at least one fiber array;
a second optical transceiver array having at least one optical receiver, wherein the second optical transceiver array is butt-coupled to a second end of the at least one fiber array to receive and direct the transmitted light.

14. The optical interconnect system of claim 13, wherein the first optical transceiver array comprises at least one optical transmitter, at least one microLED, and at least one driver for the at least one microLED.

15. The optical interconnect system of claim 14, wherein the second optical transceiver array comprise at least one optical receiver and at least one photodetector.

16. The optical interconnect system of claim 13, wherein the first optical transceiver array is electrically coupled to a first integrated circuit chip or a first area of an integrated circuit chip.

17. The optical interconnect system of claim 16, wherein the first integrated circuit chip and the at least one driver for the at least one microLED of the first optical transceiver array are mounted on a common substrate.

18. The optical interconnect system of claim 13, wherein the second optical transceiver array is electrically coupled to a second integrated circuit chip or a second area of an integrated circuit chip.

19. The optical interconnect system of claim 18, wherein the second integrated circuit chip is mounted to a common substrate.

20. The optical interconnect system of claim 13, wherein the first optical transceiver array comprises the at least one optical transmitter and the least one optical receiver; and wherein the second optical transceiver array comprises the at least one optical transmitter and the least one optical receiver.
